(19) United States
(12) Patent Application Publication
(10) Pub. No.: US 2016/0117726 A1
(43) Pub. Date: Apr. 28, 2016

(54) TRACKING, STORING, AND ANALYZING ABANDONMENT PATTERN DATA TO IMPROVE MARKETING TOOLS AVAILABLE ON A NETWORK-BASED E-COMMERCE SYSTEM

(71) Applicant: eBay Inc., San Jose, CA (US)

(72) Inventor: Daniel Lee, Phoenixville, PA (US)

(21) Appl. No.: 14/526,119

(22) Filed: Oct. 28, 2014

(51) Int. Cl. G06Q 30/02; G06Q 30/06

(52) U.S. Cl. CPC G06Q 30/0255; G06Q 30/0633

(57) ABSTRACT

A system and method for significantly improving marketing tools based on analysis of shopping cart abandonment patterns are disclosed. A server system receives a request from a client system to place a particular item in a shopping cart associated with the user of the client system. The server system then detects an abandonment action for the particular item and in response increments a user-specific abandonment counter. If the abandonment counter is then within a predetermined range, the server system generates an offer for the particular item and transmits it to the requesting client system.

### TECHNICAL FIELD

This application relates generally to the field of data storage and analysis and, more specifically, to tracking user behavior patterns through data analysis.

### BACKGROUND

The rise in electronic and digital device technology has rapidly changed the way society interacts with media and consumes goods and services. Digital technology enables a variety of consumer devices to be available that are very flexible and relatively cheap. Specifically, modern electronic devices, such as smart phones and tablets, allow a user to have access to a variety of useful applications even when away from a traditional computer. One useful application is the providing of location-based services using a position-locating module to determine when a user crosses a boundary or is near a place of interest.

E-commerce is another major application for networked computer systems. E-commerce networks allow users (both individuals and organizations) to both buy and sell products and services. A number of e-commerce sites exist and compete with each other to offer the best and most convenient services. Therefore, e-commerce networks that provide the best and most efficient services have a competitive edge.

### BRIEF DESCRIPTION OF THE DRAWINGS

The present description is illustrated by way of example, and not by way of limitation, in the figures of the accompanying drawings, in which:

FIG. 1 is a block diagram illustrating a client-server system that includes one or more client systems and a server system, in accordance with some embodiments.

FIG. 2 is a block diagram illustrating a client system, in accordance with some embodiments.

FIG. 3 is a block diagram illustrating a server system, in accordance with some embodiments.

FIG. 4 depicts a block diagram of an exemplary data structure for storing user profiles in accordance with some implementations.

FIG. 5 is a flow diagram illustrating a process for significantly improving marketing tools based on analysis of shopping cart abandonment patterns in accordance with some implementations.

FIGS. 6A-6C are flow diagrams illustrating a process for significantly improving marketing tools based on analysis of shopping cart abandonment patterns, in accordance with some implementations.

FIG. 7 is a block diagram illustrating an architecture of software that may be installed on any one or more of devices of a computer system.

FIG. 8 is a block diagram illustrating components of a machine, according to some example embodiments.

Like reference numerals refer to corresponding parts throughout the drawings.

### DETAILED DESCRIPTION

Although the implementations will be described with reference to specific example implementations, it will be evident that various modifications and changes may be made to these implementations without departing from the broader spirit and scope of the description. Accordingly, the specification and drawings are to be regarded in an illustrative rather than a restrictive sense.

In various implementations, methods and systems for significantly improving marketing tools based on analysis of shopping cart abandonment patterns are disclosed. A server system that implements an e-commerce system receives a request from a client system to put a respective item in a shopping cart enabled by the e-commerce system (e.g., a shopping cart application integrated into a web site) associated with the user of the client system. Once one or more items are added to a shopping cart, the user may choose to then purchase the item(s) or abandon the item(s) (e.g., not complete the purchase).

Once a respective item is in a user's shopping cart, the server system detects an abandonment action with respect to the respective item. Possible abandonment actions include, but are not limited to, receiving a request to remove the respective item from the shopping cart, determining that a certain amount of time has elapsed without purchase, and determining that the user has purchased other items through the e-commerce system without purchasing the respective item. In response to detecting an abandonment action for a respective item, the server system increments an abandonment count for the respective item and the specific user (e.g., there are separate abandonment counts per item for each user).

The server system determines whether the abandonment count for a respective item exceeds a predetermined number. In accordance with a determination that the abandonment exceeds a predetermined number, the server system determines that the user has high purchasing intent with respect to the respective item.

The server system uses the determined purchasing intent to generate a proposed offer for the user. The proposed offer is generated to increase the likelihood that the user will purchase the item, including price reductions, additional models/styles, free or reduced price shipping (e.g., offering a faster shipping tier), bonus items, and so on. In some example embodiments the server system generates a proposed offer by notifying the seller of the respective item and receiving offer instructions from the seller. Once the proposed offer is generated (and in some cases approved by a seller), the offer is transmitted to the buyer.

The server system records the result of each offer sent to a buyer based on an analysis of abandonment data. This data is collected and analyzed and used when generating future offers to increase the likelihood that offers will result in sales. For example, offers that were previously successful will be more likely to be selected in the future and offers that were not successful will be less likely to be selected in future offers. In this was the server system builds a large database of previous offers and their results that it can use when generating all future offers to increase the likelihood of success.

The server system can also provide abandonment information to one or more sellers that are associated (e.g., registered) with the server system so that the seller can the abandonment information to improve the seller's marketing efforts and/or future product line. In some example embodiments the server system analyzes the abandonment data to identify products that would benefit from a specific offer (e.g., products that would see a large rise in sales based on a small reduction in price, and so on). The server system identifies potentially popular products and also suggests one or more offers that the seller can choose to make. Once an offer and a product are selected, the server system sends out the offer (or displays it when the user visits the e-commerce web site) to identified users. The server system tracks the resulting sales and generates a report for the seller based on the outcome of the offer.

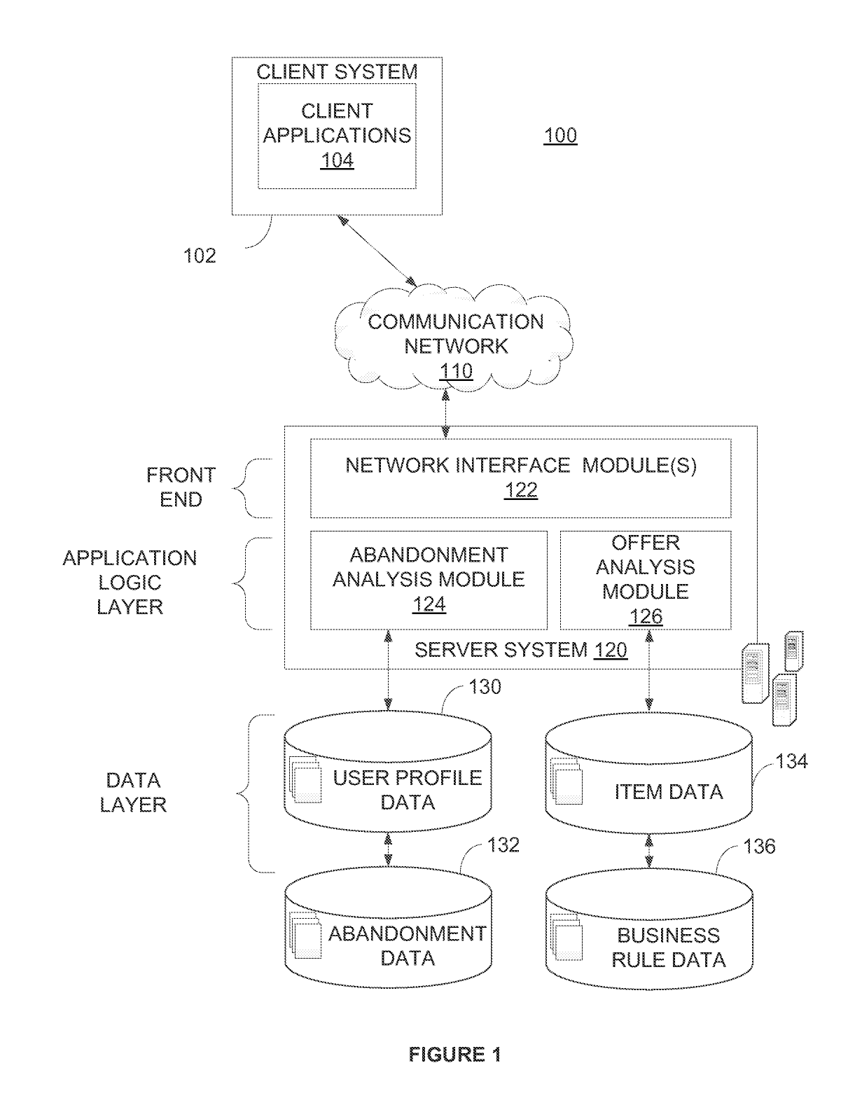

FIG. 1 is a block diagram illustrating a client-server system 100 that includes one or more client systems 102 and a server system 120. One or more communication networks 110 interconnect these components. The communication network 110 may be any of a variety of networks, including local area networks (LAN), wide area networks (WAN), wireless networks, wired networks, the Internet, personal area networks (PAN), or a combination of such networks.

In some example embodiments, a client system 102 is an electronic device, such as a personal computer (PC), a laptop, a smartphone, a tablet, a mobile phone, a wearable computing device, or any other electronic device capable of communication over the communication network 110. Some client systems 102 include one or more client applications 104, which are executed by the client system 102. In some example embodiments, the client application(s) 104 include one or more applications from a set consisting of search applications, communication applications, productivity applications, storage applications, word processing applications, travel applications, or any other useful applications. The client system 102 uses the client application(s) 104 to communicate with the server system 120 and transmit data to, and receive data from, the server system 120.

In some example embodiments, as shown by way of example in FIG. 1, the server system 120 generally includes three types of components, including front-end components, application logic components, and data components. As is understood by skilled artisans in the relevant computer and Internet-related arts, each module or engine shown in FIG. 1 represents a set of executable software instructions and the corresponding hardware (e.g., memory and processor) for executing the instructions. To avoid unnecessary detail, various functional modules and engines that are not germane to conveying an understanding of the various example embodiments have been omitted from FIG. 1. However, a skilled artisan will readily recognize that various additional functional modules and engines may be used with a server system 120, such as that illustrated in FIG. 1, to facilitate additional functionality that is not specifically described herein. Furthermore, the various functional modules and engines depicted in FIG. 1 may reside on a single server computer or may be distributed across several server computers in various arrangements. Moreover, although depicted in FIG. 1 as a three component type of architecture, the various example embodiments are by no means limited to this architecture.

As shown by way of example in FIG. 1, the server system 120 includes network interface module(s) (e.g., a web server) 122, which receives data from various client systems 102, and communicates data back to the appropriate client systems 102 when appropriate. For example, the network interface module(s) 122 receives a shopping cart request (e.g., a request to place a specific item in a shopping cart application associated with the e-commerce system) from a client system 102 and transmits the shopping cart request to the abandonment analysis module 124. The abandonment analysis module 124 (or other more module) then accesses user shopping cart data (e.g., stored in the user profile data 130) to add the specific item to the shopping cart associated with the user. The network interface module(s) 122 then transmits a confirmation to the client system 102 for display.

As shown by way of example in FIG. 1, the data components include user profile data 130 for storing data associated user in a plurality of users of the server system (e.g., server system 120 in FIG. 1) geo-fences. The terms “database,” “data,” “dataset,” and “data storage” are used interchangeably in the specification to refer to data that may or may not be stored in a specific database depending on the exact configuration used in a particular embodiment.

The application logic components include an abandonment analysis module 124 and an offer analysis module 126. The abandonment analysis module 124 records abandonment actions from users of one or more client systems 102. The offer analysis module 126 uses the stored abandonment data 132 to generate one or more offers for a specific item for one or more users of the e-commerce system.

The abandonment analysis module 124 receives a request from a client system 102. The request identifies a particular product offered through the server system 120 and instructs the abandonment analysis module 124 to store the particular product in a shopping cart (e.g., functionality made available through one or more modules on the server system (e.g., server system 120 in FIG. 1)) associated with the user of the client system 102. In some example embodiments, the abandonment analysis module 124 then receives an abandonment action from the client system 102. In some example embodiments, the abandonment action includes, but it not limited to, closing the browsing window without purchasing the particular item, removing the particular item from the shopping cart, or detecting certain amount of time has elapsed without a purchase action by the user.

In some example embodiments, in response to detecting an abandonment action for a particular item, the abandonment analysis module 124 increments an abandonment count for the particular item and the user that initiated the abandonment. In some example embodiments, each user has a list of abandoned items. Each abandoned item in the list of abandoned items includes an abandonment count that represents the number of times the item has been abandoned by the user.

In some example embodiments, the offer analysis module 126 analyzes the abandonment count for a particular item. The offer analysis module 126 determines whether the abandonment count for a particular item in the list of abandoned items of a user is above a predetermined number. For example, an abandonment count above three (the predetermined number in this example) indicates a high likelihood of purchasing intent. In some example embodiments, the offer analysis module 126 determines whether the abandonment count is within a specific range.

In some example embodiments, in accordance with a determination that the abandonment count for a particular item is above a certain amount (or within a particular range), the offer analysis module 126 selects an offer to send to the user. In some example embodiments, the offer is based on business rules established by the seller of the particular item (e.g., rules determining what offers may be made based on the characteristics of the item, the characteristics of the user, the time of year, and so on). For example, a business rule from seller A establishes that no price reduction over ten percent should be made on seller A's products without explicit permission from seller A. Furthermore, seller A's business rules also state that free shipping should not be offered to users with shipping addresses

In other example embodiments, the offer analysis module 126 sends a notification to the seller wherein the notification details the user interest and abandonment data 132 and identifies the particular item. The offer analysis module 126 receives an offer determination from the seller. In this example, the seller actually determines the specific offer, in accordance with the sellers' marketing plan.

In some example embodiments, the offer analysis module 126 selects an offer and transmits it to the user via the client system 102. For example, the offer analysis module 126 sends an email to the email address associated with the client system 102. In other embodiments the offer analysis module 126 sends an internal message (or any other message type) to the user.

Once the offer has been transmitted to the client system (e.g., system 102), the offer analysis module 126 tracks the results of the offer. The offer analysis module 126 determines whether any sales resulted from the offers. In some example embodiments, the offer analysis module 126 sends a follow up message to the user with a survey to determine the effect of the offer on the user's purchase decision (or lack of purchase decision).

As shown in FIG. 1, the data layer includes several databases, including databases for storing user profile data 130, abandonment data 132, item data 134, and business rule data 136.

In some example embodiments the user profile data 130 stores user profiles for a plurality of users of the server system 120. These user profiles include all the information that the server system 120 stores for a particular user, including but not limited to, user name, gender, age, location, contact information, social connections, education, work history, past item purchases, user purchase rate, and skills.

In some implementations, the user profile data 130 includes abandonment data 132. In other embodiments the abandonment data 132 is separate from but associated with the user profile data 130. Abandonment data 132 includes, for each user, a list of items that have been placed in a shopping cart and then abandoned by the user. The abandonment data 132 for each user includes an abandonment count for each item, wherein the abandonment count for an item records the number of times a specific user has abandoned an item. In some example embodiments, the abandonment data 132 also includes overall abandonment data, wherein overall abandonment data includes the total number of abandons for each item offered by the e-commerce network associated with the server system 120.

In some example embodiments, the item data 134 stores information for each item offered on the e-commerce network associated with the server system 120. For example, the item data 134 stores the price, color (if appropriate), SKU model number, shipping details, manufacturer, seller, specifications (e.g., size, compatibility, and so on), and availability (e.g., by country).

In some example embodiments, the business rule data 136 includes business rules received from the sellers/manufactures of particular item in the item data 134. The business rules outline if and how offers can be generated for specific items. For example, business rules for a smart phone indicate that if abandonment data 132 shows a user has a high chance of purchasing if given a discounted price, the server system 120 may offer up to a ten percent discount but no more.

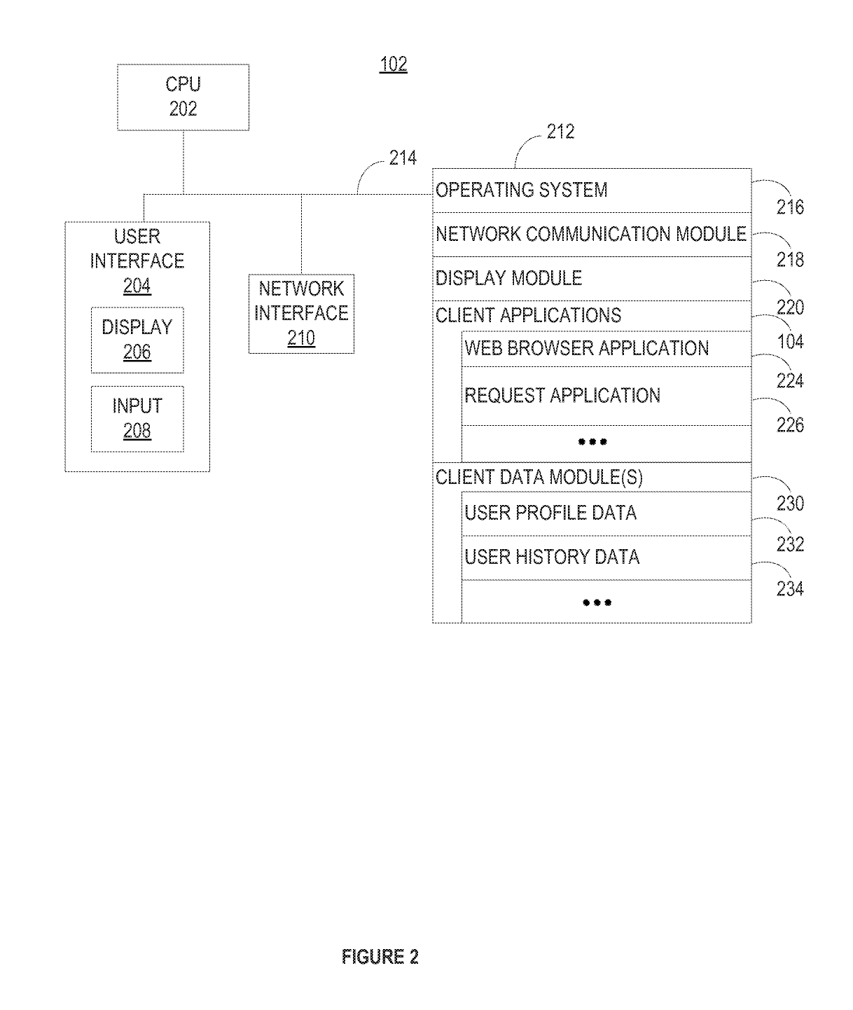

FIG. 2 is a block diagram further illustrating the client system 102, in accordance with some example embodiments. The client system 102 typically includes one or more central processing units (CPUs) 202, one or more network interfaces 210, memory 212, and one or more communication buses 214 for interconnecting these components. The client system 102 includes a user interface 204. The user interface 204 includes a display device 206 and optionally includes an input means such as a keyboard, mouse, a touch sensitive display, or other input buttons 208. Furthermore, the client system 102 may use a microphone and voice recognition to supplement or replace the keyboard as a means of input.

Memory 212 includes high-speed random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. Memory 212 may optionally include one or more storage devices remotely located from the CPU(s) 202. Memory 212, or alternately the non-volatile memory device(s) within memory 212, comprises a non-transitory computer readable storage medium.

In some example embodiments, memory 212, or the computer readable storage medium of memory 212, stores the following programs, modules, and data structures, or a subset thereof:
an operating system 216 that includes procedures for handling various basic system services and for performing hardware dependent tasks;
a network communication module 218 used for connecting the client system 102 to other computers via the one or more communication network interfaces 210 (wired or wireless) and one or more communication networks (e.g., communication network 110 of FIG. 1), such as the Internet, other WANs, LANs metropolitan area networks (MANs), etc.;
a display module 220 for enabling the information generated by the operating system 216 to be presented visually as needed;
one or more client applications 104 for handling various aspects of requesting and receiving numbers, including but not limited to:
   a web browser application 224 for receiving and displaying web page data from one or more server systems (e.g., server system 120 in FIG. 1) over a communication network (e.g., network 110 in FIG. 1); and
   a request application 226 for sending a shopping cart request to the server system (e.g., server system 120 in FIG. 1) to place a particular item in a shopping cart provided by the server system; and
client data module(s) 230 for storing data at the client system 102, including but not limited to:
   user profile data 232 including information stored by the client system 102, including but not limited to, user name, gender, age, location, contact information, social connections, education, work history, past item purchases, user purchase rate, and user browsing habits; and
   user history data 234 including data about past browsing history, past items selected to go in a shopping cart, and so on.

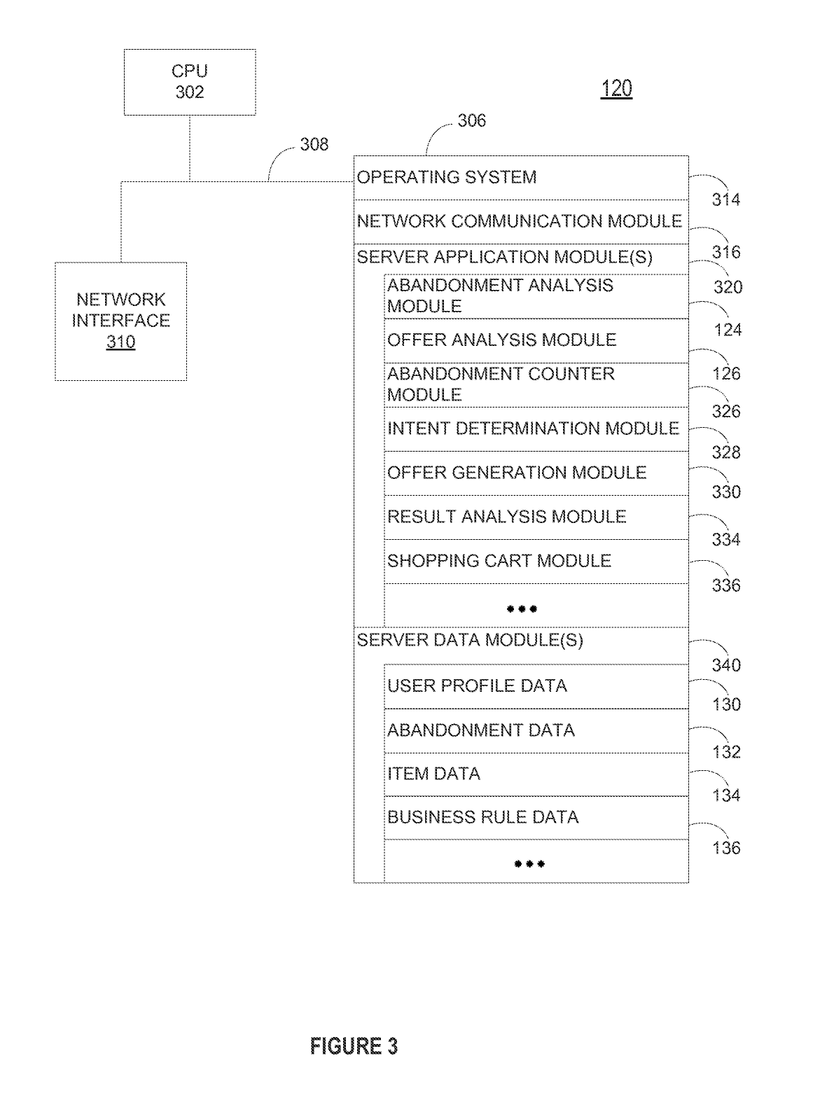

FIG. 3 is a block diagram illustrating the server system 120, in accordance with some embodiments. The server system 120 typically includes one or more central processing units (CPUs) 302, one or more network interfaces 310, memory 306, and one or more communication buses 308 for interconnecting these components. Memory 306 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 306 may optionally include one or more storage devices remotely located from the CPU(s) 302.

Memory 306, or alternately the non-volatile memory device(s) within memory 306, comprises a non-transitory computer readable storage medium. In some embodiments, memory 306 or the computer readable storage medium of memory 306 stores the following programs, modules, and data structures, or a subset thereof:
an operating system 314 that includes procedures for handling various basic system services and for performing hardware dependent tasks;
a network communication module 316 that is used for connecting the server system 120 to other computers via the one or more communication network interfaces 310 (wired or wireless) and one or more communication networks, such as the Internet, other WANs, LANS, MANs, and so on;
one or more server application modules 320 for performing the services offered by server system 120, including but not limited to:
   the abandonment analysis module 124 for receiving requests to place a particular item in a shopping cart for the user, detecting user abandonment, and incrementing abandonment totals in response to detecting abandonment actions;
   the offer analysis module 126 for determining an offer to send to a user based on abandonment data 132;
   an abandonment counter module 326 for tracking the number of times an item is abandoned, both on a per user basis and an overall system basis;
   an intent determination module 328 for determining a user's purchasing intent based on the user's abandonment data 132;
   an offer generation module 330 for determining an offer to send to one or more users of the e-commerce system based on business rule data 136, user profile data 130, and abandonment data 132;
   a result analysis module 334 for determining the outcome of the offer sent to one or more users; and
   a shopping cart module 336 for implementing a shopping cart feature for the e-commerce system that is associated with the server system (e.g., server system 120 in FIG. 1); and
server data module(s) 340, holding data related to server system 120, including but not limited to:
   user profile data 130 including profile data regarding the user associated with the client system 102 including, but not limited to, demographic information about the user, user interest information, user history information, and any other information regarding the user;
   abandonment data 132 including user-specific abandonment counts and global abandonment counts for items;
   item data 134 including information for each item offered on the e-commerce network associated with the server system 120 such as the price, color (if appropriate), SKU model number, shipping details, manufacturer, seller, specifications (e.g., size, compatibility, and so on), and availability (e.g., by country); and
   business rule data 136 including business rules received from the sellers/manufactures of particular items in the item data 134, wherein the business rules outline if and how offers can be generated for specific items.

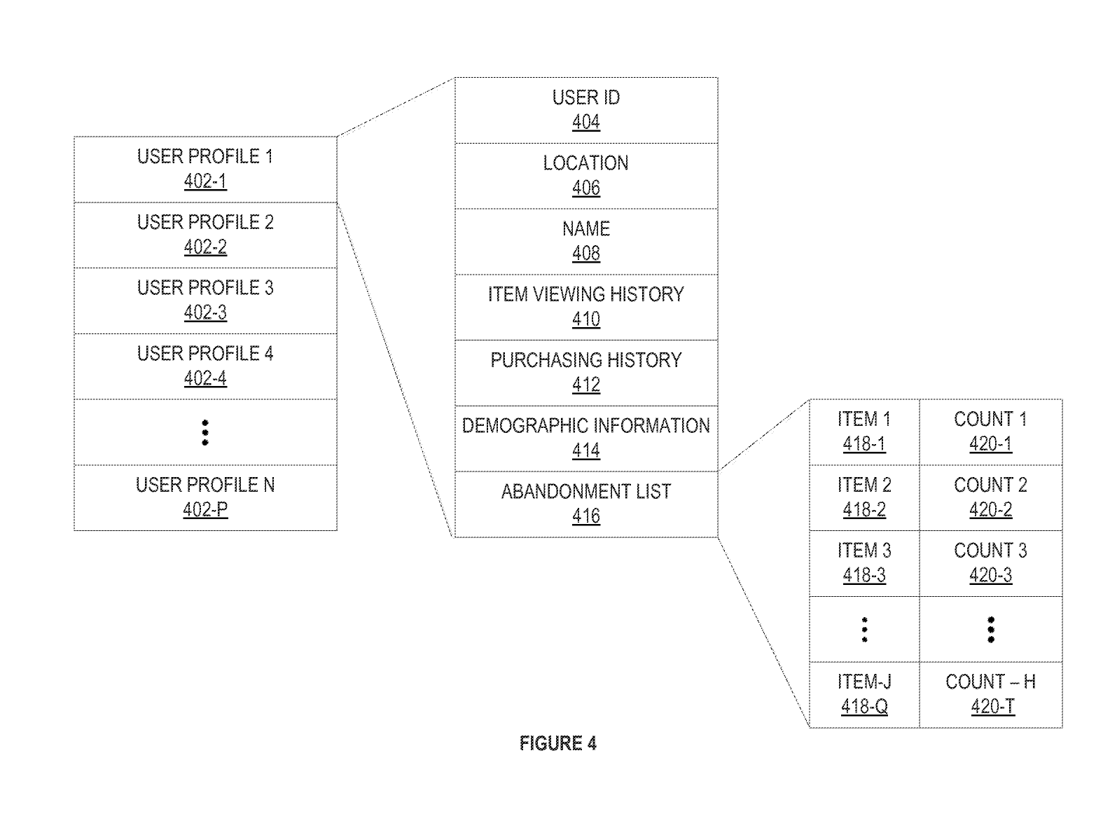

FIG. 4 depicts a block diagram of an exemplary data structure for the user profile data 130 for storing user profiles in accordance with some implementations. In accordance with some implementations, the user profile data 130 includes a plurality of user profiles 402-1 to 402-P, each of which corresponds to a user of the server system (e.g., server system 120 of FIG. 1).

In some implementations, a respective user profile 402 stores a unique user ID 404 for the user profile 402, a location 406 associated with the user, a name 408 for the user (e.g., the user's legal name), item viewing history 410 (e.g., detailing what items the user has viewed over a given period of time), purchasing history 412 (e.g., a list of purchases made by the user over a given period of time), demographic information 414 of the user (e.g., the user's age, gender, race, and so on), and an abandonment list 416 for the user.

In some example embodiments, a user profile 402 includes an abandonment list 416, wherein each item in the abandonment list 416 was abandoned by the user after the item was placed in the user's shopping cart in response to a user request to place it in the shopping cart. Each item in the abandonment list 416 (418-1 to 418-Q) has an associated count (420-1 to 420-T) that represents the number of times the user has abandoned the item (e.g., each time the user places the item in a shopping cart and then abandons it, the count increments by one).

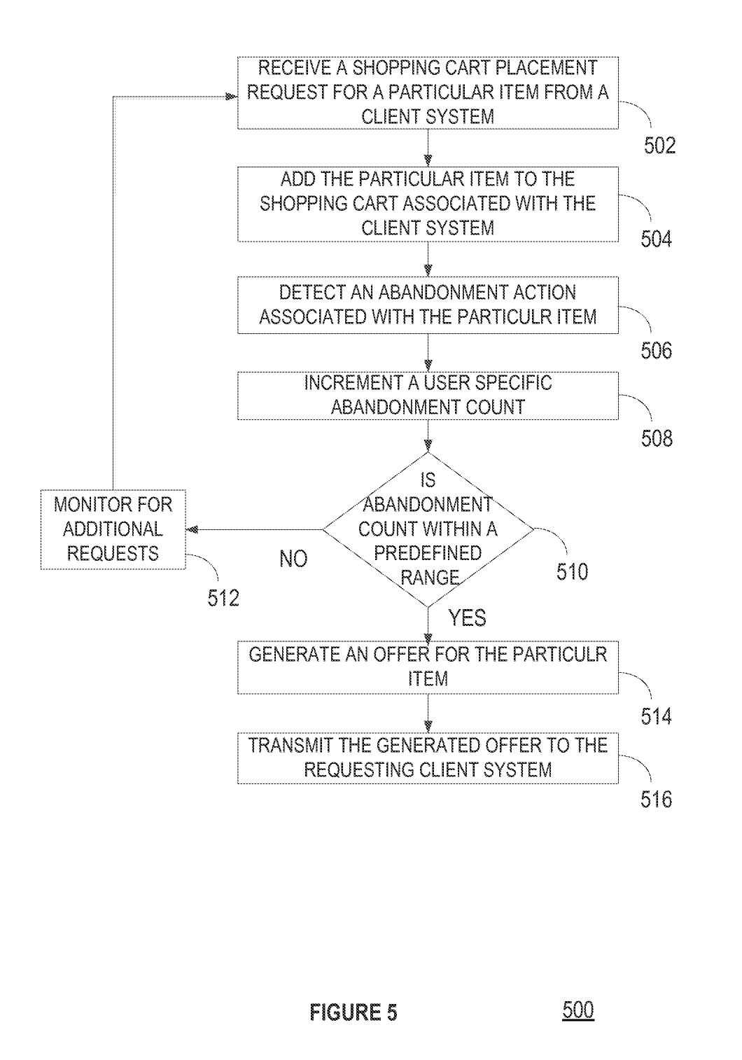

FIG. 5 is a flow diagram illustrating a process for significantly improving marketing tools based on analysis of shopping cart abandonment patterns in accordance with some implementations. Each of the operations shown in FIG. 5 corresponds, in some embodiments, to instructions stored in a computer memory or computer readable storage medium. In some implementations, the method 500 described with reference to FIG. 5 is performed by a server system (e.g., server system 120 in FIG. 1).

The method 500 is performed at a client system (e.g., client system 102 in FIG. 1) including one or more processors and memory storing one or more programs for execution by the one or more processors. The server system receives (502) a shopping cart placement request for a particular item from a client system. In some example embodiments, the request identifies a user or user account associated with the shopping cart placement request. The shopping cart is functionally implemented by the web site associated with an e-commerce system that is analogous to a real-life shopping cart (e.g., a user can store multiple items and then easily purchase them all at once when the user is ready.

The server system (e.g., system 120 in FIG. 1) adds (504) the particular item to the shopping cart associated with the client system (e.g., system 102 in FIG. 1). The server system then detects (506) an abandonment action associated with the particular item. An abandonment action includes, but is not limited to, removing the particular item from the shopping cart, a user closing the browser window associated with the e-commerce system without purchasing the particular item, and determining that a certain amount of time has elapsed since the particular item was added to the shopping cart.

In some example embodiments, the server system (e.g., server system 120 in FIG. 1), in response to detecting an abandonment action with respect to a particular item, increments (508) a user-specific abandonment count. The server system stores an abandonment list (e.g., abandonment list 416 in FIG. 4) for each user of the server system. Each respective user has a user-specific abandonment list that includes a list of all items abandoned by the respective user (e.g., over a given period of time). Each item in the user-specific abandonment list also has an associated abandonment count that indicates the number of times the respective user has abandoned the item.

The server system (e.g., server system 120 in FIG. 1) determines (510) whether the abandonment count for the particular item is within a predefined range. In some example embodiments, the predefined range is any number above a given amount (e.g., more than three abandonments). In other embodiments, the predefined range is less than a specific amount (e.g., fewer than seven abandonments). In yet other embodiments, the predefined range is more than a first amount and less than a second amount (e.g., between three and seven).

In accordance with a determination that the abandonment count is not within a predefined amount, the server system (e.g., server system 120 in FIG. 1) continues to monitor (512) future communications for shopping cart placement requests.

In accordance with a determination that the abandonment count is within a predefined amount, the server system (e.g., server system 120 in FIG. 1) generates (514) an offer for the particular item. A generated offer can include, but is not limited to, a price reduction, a reduction in shipping costs or shipping time, model or option upgrades, and so on.

The server system (e.g., server system 120 in FIG. 1) sends (516) the generated offer to the requesting client system (e.g., client system 102 in FIG. 1). For example, the server system can send an email containing the offer (or a link to the offer). In other embodiments, the server system sends an internal message through the e-commerce system to the user of the client system.

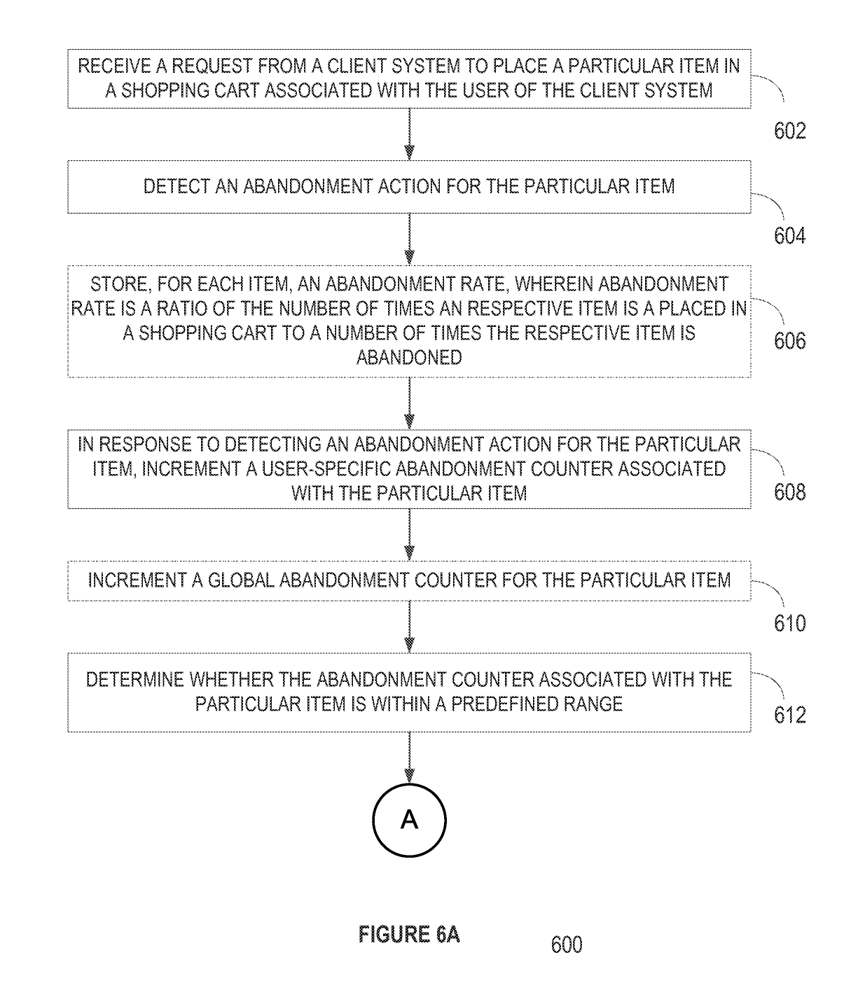

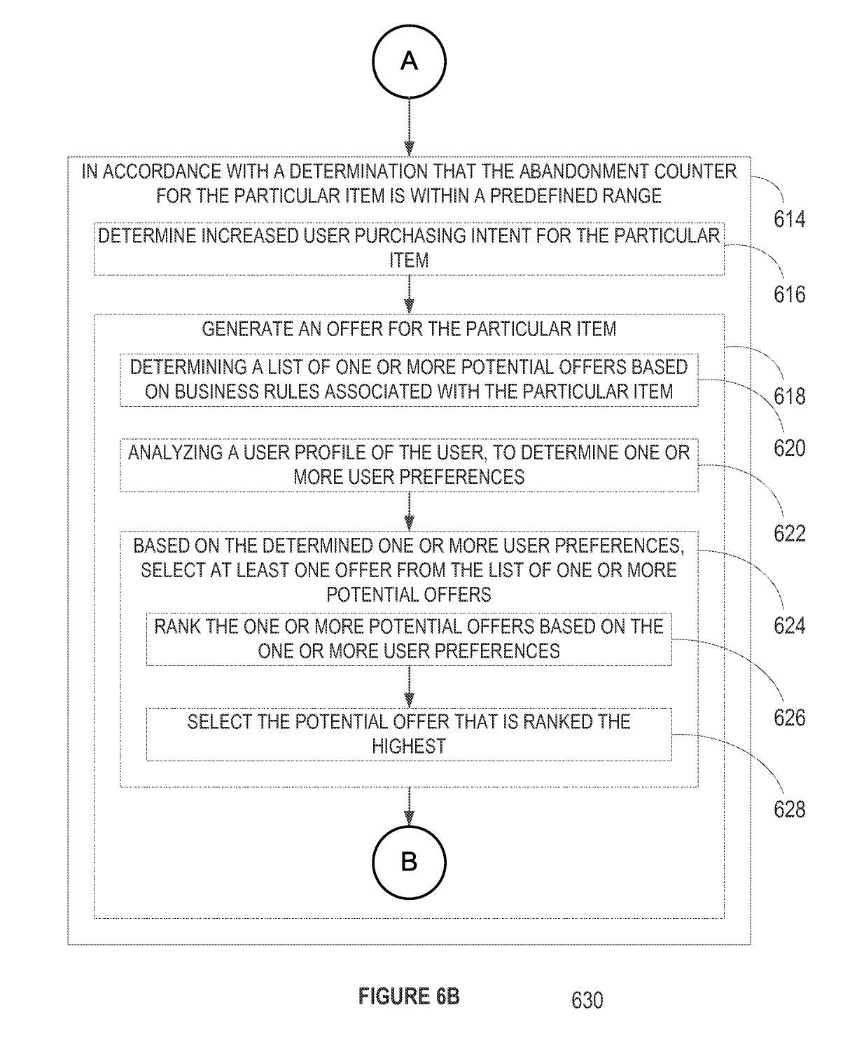

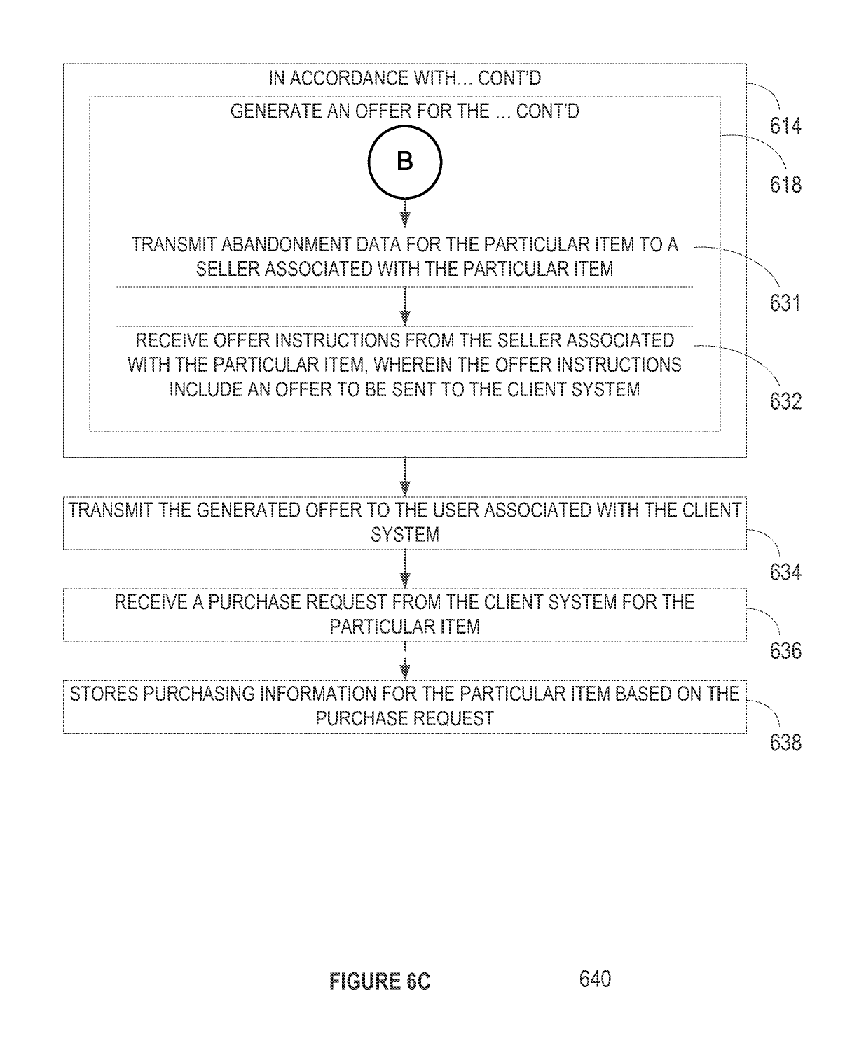

FIG. 6A is a flow diagram illustrating a method 600 for significantly improving marketing tools based on analysis of shopping cart abandonment patterns in accordance with some implementations. Each of the operations shown in FIG. 6A may correspond to instructions stored in a computer memory or computer readable storage medium. Optional operations are indicated by dashed lines (e.g., boxes with dashed-line borders). In some implementations, the method described in FIG. 6A is performed by a server system (e.g., server system 120 in FIG. 1). However, the method described can also be performed by any other suitable configuration of electronic hardware.

In some implementations the method is performed at a server system (e.g., server system 120 in FIG. 1) including one or more processors and memory storing one or more programs for execution by the one or more processors.

The server system (e.g., server system 120 in FIG. 1) receives (602) a request from a client system (e.g., client system 102 in FIG. 1) to place a particular item in a shopping cart associated with the user of the client system. A shopping cart (e.g., an web-based shopping cart) is a module or functionality provided by an electronic e-commerce system that allows users to emulate the functionality of an actual shopping cart so that users can place items within that they intend to purchase (or are considering purchasing). Once all the items a user is considering purchasing are placed in the shopping cart, the user can then purchase them all at once. In some example embodiments, the request received from the client system includes information identifying the item to be placed in the shopping cart, the user requesting the item to be placed in the shopping cart (e.g., the user ID), and the shopping cart to place the item in (e.g., in some cases a user may have multiple shopping carts for different purposes).

For example, the server system (e.g., server system 120 in FIG. 1) receives a request from a client system (e.g., system 102 in FIG. 1) that indicates that a copy of the movie “Frozen,” on DVD, is to be placed in shopping cart one associated with user “Bob.” The server system then updates the shopping cart data for user “Bob” to add the DVD “Frozen” to shopping cart one.

In some example embodiments, the server system (e.g., server system 120 in FIG. 1) detects (604) an abandonment action for the particular item in the shopping cart. In some example embodiments, detecting an abandonment action for the particular item comprises detecting that a user has closed a web page associated with an e-commerce system without purchasing the particular item. For example, if a user has placed Item A in a shopping cart and then closes the webpage (e.g., such that no active web page is displayed at the client system (e.g., client system 102 in FIG. 1)) the server system will detect an abandonment action with respect to Item A.

In other embodiments, detecting an abandonment action for the particular item comprises detecting that at least a predetermined amount of time has elapsed since the request was received from the client system (e.g., client system 102 in FIG. 1). For example, if more than 24 hours has passed (or another predetermined amount of time) the server system (e.g., server system 120 in FIG. 1) then determines that the item has been abandoned. In yet other embodiments, detecting an abandonment action for the particular item comprises receiving a request to remove the particular item from the shopping cart.

In some example embodiments, the server system (e.g., server system 120 in FIG. 1) stores (606), for each item available through the e-commerce system associated with the server system, an abandonment rate, wherein the abandonment rate is a ratio of the number of times a respective item is a placed in a shopping cart to a number of times the respective item is abandoned across the entire server system (e.g., server system 120 in FIG. 1). For example, an item that has been placed in shopping carts 10,000 times and then abandoned 2000 times would have an abandonment rate of 20% (2000/10000).

In some example embodiments, in response to detecting an abandonment action for the particular item, the server system (e.g., server system 120 in FIG. 1) increments (608) a user-specific abandonment counter associated with the particular item. In some example embodiments, the server system stores, for each user, a list of abandoned items (e.g., abandonment list 416 of FIG. 4). Each item on a specific user's abandoned list includes an abandonment count (e.g., the number of times the user has abandoned that specific item.) The server system increments the abandonment count for an item (or adds a new abandoned item to the list) whenever an abandonment action is detected. In some example embodiments, items on the abandonment list are removed after a certain amount of time. For example, items that were last abandonment by a user more than one year ago likely do not need to be stored for the user.

In some example embodiments, each user has an associated abandonment rate. An abandonment rate for a user is a ratio of the number of items that the user abandons to the number of items the user places in their shopping cart. For example, if a user places fifty items in their shopping cart and abandons 25 of them, the abandonment rate for the user is 50%. In some example embodiments, the server system (e.g., server system 120 in FIG. 1) uses the abandonment rate for a user to determine whether the user frequently abandons items they place in their shopping cart. In some example embodiments, the server system also tracks the rate at which abandoned items are eventually purchased by the user. This rate can be called the eventual conversion rate. For example, a user who abandons three items in a given time period but then later purchases them all will have an eventual conversion rate of 100%.

In some example embodiments, after detecting an abandonment action for the particular item, the server system (e.g., server system 120 in FIG. 1) increments (610) a global abandonment counter (e.g., across all users or some subset of users) for the particular item. For example, in addition to the user-specific counters for particular items, the server system stores a global count of abandonment actions for each item. In this way the server system can determine when an item is generally interesting to users but needs additional attention to increase conversion rates (e.g., an offer). In some example embodiments, the server system can also store abandonment rates by country or other factors.

In some example embodiments, the server system (e.g., server system 120 in FIG. 1) determines (612) whether the abandonment count associated with the particular item is within a predefined range. In some example embodiments, the predefined range only has a lower limit (e.g., to be within the range the count only need be above five). In other embodiments the predefined range only has an upper limit (e.g., to be within the range the count only need be below ten). In yet other embodiments, the range has both an upper and a lower limit (e.g., to be within the range the count needs to be above five and below ten).

FIG. 6B is a flow diagram illustrating a method 630 for significantly improving marketing tools based on analysis of shopping cart abandonment patterns in accordance with some implementations. Each of the operations shown in FIG. 6B may correspond to instructions stored in a computer memory or computer readable storage medium. Optional operations are indicated by dashed lines (e.g., boxes with dashed-line borders). In some implementations, the method described in FIG. 6B is performed by the server system (e.g., server system 120 in FIG. 1). However, the method described can also be performed by any other suitable configuration of electronic hardware.

In some implementations the method is performed at a server system (e.g., server system 120 in FIG. 1) including one or more processors and memory storing one or more programs for execution by the one or more processors.

In some example embodiments, in accordance with a determination (614) that the abandonment count for the particular item is within a predefined range, the server system (e.g., server system 120 in FIG. 1) determines (616) increased user purchasing intent for the particular item. For example, the server system uses abandonment counts to estimate the likelihood that the user will purchase the item (e.g., the user's purchasing intent). The server system determines that users who have abandoned an item more than three times but less than six, have a high likelihood of purchasing the item eventually (given the right offer) and users with abandonment counts outside this range have low likelihood of purchasing the item regardless of whether an offer is made. In some example embodiments, the determined likelihood that the user will eventually purchase the item is also based on the user's own abandonment rate. For example, users who frequently abandon items will be determined to be less likely to eventually purchase an abandoned item than users who rarely abandon items.

In some example embodiments, the server system (e.g., server system 120 in FIG. 1) generates (618) an offer for the particular item. In some example embodiments, generating an offer for the particular item further comprises the server system determining (620) a list of one or more potential offers based on business rules associated with the particular item. Business rules associated with a particular item are received from a seller associated with the particular item and outline the offers that the server system is authorized to make to a potential buyer.

In some example embodiments, the business rules determine possible offers based on the demographics of the user, the location of the user, and the likelihood that the user will purchase in response to the offer. For example, the business rules for a cheese grater allow offers of up to five percent discount on price and free shipping to users within the lower 48 states and Canada. In some example embodiments the seller is an individual or an organization.

In some example embodiments, generating an offer for the particular item further comprises the server system (e.g., server system 120 in FIG. 1) analyzing (622) a user profile of the user, to determine one or more user preferences. For example, the server system can analyze past accepted and refused offers to determine what kinds of offers the user is most likely to respond to. Some users respond primarily to reductions in price while other users respond to free shipping. In some example embodiments, the server system determines that a particular user favors a specific color, brand, or motif and can offer a different visual appearance or style for the product.

In some example embodiments, based on the determined one or more user preferences, the server system (e.g., server system 120 in FIG. 1) selects (624) at least one offer from the list of one or more potential offers. For example, if the user has a strong preference (based on past offers) for shipping based offers, the server system then selects an offer that includes reduced or free shipping.

In some example embodiments, selecting at least one offer from the list of one or more potential offers includes the server system (e.g., server system 120 in FIG. FIG. 1) ranking (626) the one or more potential offers based on the one or more user preferences. In some example embodiments, ranking includes generating a match score for each potential offer and then sorting from highest to lowest based on the match score. The server system selects (628) the potential offer that is ranked the highest.

FIG. 6C is a flow diagram illustrating a method 640 for significantly improving marketing tools based on analysis of shopping cart abandonment patterns in accordance with some implementations. Each of the operations shown in FIG. 6C may correspond to instructions stored in a computer memory or computer readable storage medium. Optional operations are indicated by dashed lines (e.g., boxes with dashed-line borders). In some implementations, the method described in FIG. 6C is performed by the server system (e.g., server system 120 in FIG. 1). However, the method described can also be performed by any other suitable configuration of electronic hardware.

In some implementations the method is performed at a server system (e.g., server system 120 in FIG. 1) including one or more processors and memory storing one or more programs for execution by the one or more processors.

In another example embodiments, generating an offer for the particular item further comprises the server system (e.g., server system 120 in FIG. 1) transmitting (631) abandonment data for the particular item to a seller associated with the particular item. For example, the server system sends the information to the seller when an abandonment count enters a particular range. The server system receives (632) offer instructions from the seller associated with the particular item, wherein the offer instructions include an offer to be sent to the client system (e.g., client system 102 in FIG. 1). Thus, the seller, not the server system (e.g., server system 120 in FIG. 1) actually determines the specific offer that should be sent as part of its marketing plan. For example, the server system receives seller instructions that one or more users should be sent an offer for a ten percent price reduction for a particular item.

In some example embodiments, the seller is able to generate an offer because it has access to all the abandonment data for the seller's products and can choose sales campaigns based on the information in that data. For example, if the abandonment data shows that a particular item (or group of items) is frequently abandoned by users who have a strong preference for red items, the seller can produce newer versions or models of that item in red. In another example, if a certain product is not offered to inhabitants of a particular geo-graphic area but users who live there continually add the item to their cart only to abandon it later when they realize it is not available for them to purchase, the seller may open a new area for sales.

In some example embodiments, the server system (e.g., server system 120 in FIG. 1) sends recommendations to the seller for specific sales campaigns or offers based on the abandonment data. The seller can then reply approving or refusing the proposed offer. The server system then receives the response from the seller and responds accordingly.

In some example embodiments, the server system (e.g., server system 120 in FIG. 1) then transmits (634) the generated offer to the user associated with the client system (e.g., client system 102 in FIG. 1). The offer can be sent by any medium available to the server system including but not limited to email, internal message, SMS message, voice mail, and so on.

In some example embodiments, after transmitting the generated offer for the particular item to the server system (e.g., server system 120 in FIG. 1), the server system receives (636) a purchase request from the client system (e.g., client system 102 in FIG. 1) for the particular item. In some example embodiments, the server system stores (638) purchasing information for the particular item based on the purchase request. For example, the server system stores how many users responded to a particular offer. In some example embodiments, the server system sends surveys to users to gather data about why they accepted or refused the offer and whether the offer was the motivating factor in their purchase. This data is stored and analyzed for future recommended offers.

### Software Architecture

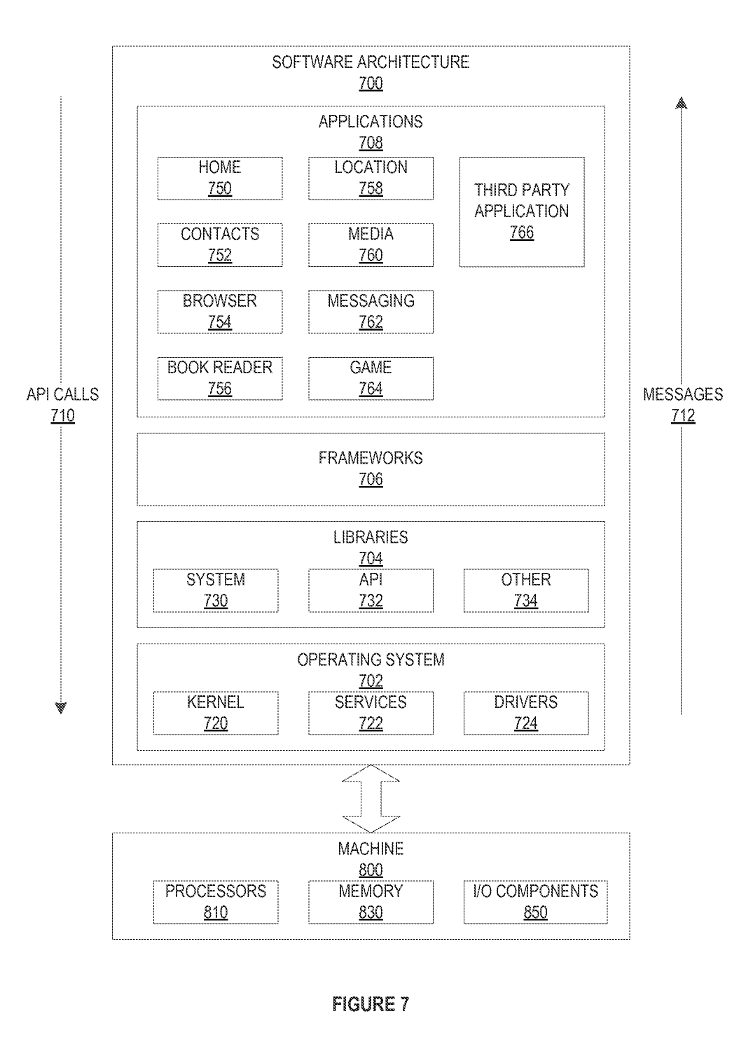

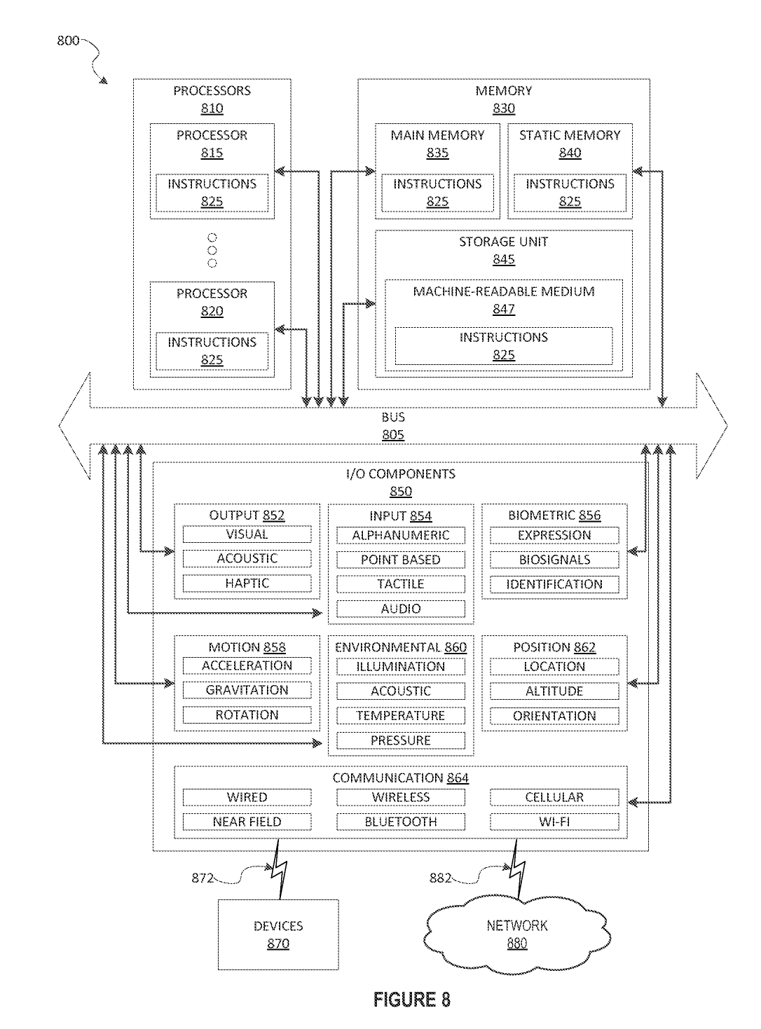

FIG. 7 is a block diagram illustrating an architecture of software 700, which may be installed on any one or more of the devices of FIG. 1 (e.g., client system(s) 102). FIG. 7 is merely a non-limiting example of a software architecture that can be used in various computer systems described herein (e.g., client system seen in FIG. 2 or the server system seen in FIG. 3 and it will be appreciated that many other architectures may be implemented to facilitate the functionality described herein. The software 700 may be executing on hardware such as machine 800 of FIG. 8 that includes processors 810, memory 830, and I/O components 850. In the example architecture of FIG. 7, the software 700 may be conceptualized as a stack of layers where each layer may provide particular functionality. For example, the software 700 may include layers such as an operating system 702, libraries 704, frameworks 706, and applications 708. Operationally, the applications 708 may invoke application programming interface (API) calls 710 through the software stack and receive messages 712 in response to the API calls 710.

The operating system 702 may manage hardware resources and provide common services. The operating system 702 may include, for example, a kernel 720, services 722, and drivers 724. The kernel 720 may act as an abstraction layer between the hardware and the other software layers. For example, the kernel 720 may be responsible for memory management, processor management (e.g., scheduling), component management, networking, security settings, and so on. The services 722 may provide other common services for the other software layers. The drivers 724 may be responsible for controlling and/or interfacing with the underlying hardware. For instance, the drivers 724 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth.

The libraries 704 may provide a low-level common infrastructure that may be utilized by the applications 708. The libraries 704 may include system libraries 730 (e.g., C standard library) that may provide functions such as memory allocation functions, string manipulation functions, mathematic functions, and the like. In addition, the libraries 704 may include API libraries 732 such as media libraries (e.g., libraries to support presentation and manipulation of various media format such as MPREG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 704 may also include a wide variety of other libraries 734 to provide many other APIs to the applications 708.

The frameworks 706 may provide a high-level common infrastructure that may be utilized by the applications 708. For example, the frameworks 706 may provide various graphic user interface (GUI) functions, high-level resource management, high-level location services, and so forth. The frameworks 706 may provide a broad spectrum of other APIs that may be utilized by the applications 708, some of which may be specific to a particular operating system or platform.

The applications 708 include a home application 750, a contacts application 752, a browser application 754, a book reader application 756, a location application 758, a media application 760, a messaging application 762, a game application 764, and a broad assortment of other applications such as third party application 766. In a specific example, the third party application 766 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third party application 766 may invoke the API calls 710 provided by the mobile operating system 702 to facilitate functionality described herein.

### Example Machine Architecture and Machine-Readable Medium

FIG. 8 is a block diagram illustrating components of a machine 800, according to some example embodiments, able to read instructions from a machine-readable medium (e.g., a machine-readable storage medium) and perform any one or more of the methodologies discussed herein. Specifically, FIG. 8 shows a diagrammatic representation of the machine 800 in the example form of a computer system, within which instructions 825 (e.g., software, a program, an application, an applet, an app, or other executable code) for causing the machine 800 to perform any one or more of the methodologies discussed herein may be executed. In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but be not limited to, a server computer, a client computer, a PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 825, sequentially or otherwise, that specify actions to be taken by machine 800. Further, while only a single machine 800 is illustrated, the term “machine” shall also be taken to include a collection of machines 800 that individually or jointly execute the instructions 825 to perform any one or more of the methodologies discussed herein.

The machine 800 may include processors 810, memory 830, and I/O components 850, which may be configured to communicate with each other via a bus 805. In an example embodiment, the processors 810 (e.g., a CPU, a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 815 and processor 820 that may execute instructions 825. The term “processor” is intended to include a multi-core processor that may comprise two or more independent processors (also referred to as “cores”) that may execute instructions contemporaneously. Although FIG. 8 shows multiple processors 810, the machine 800 may include a single processor with a single core, a single processor with multiple cores (e.g., a multi-core process), multiple processors with a single core, multiple processors with multiples cores, or any combination thereof.

The memory 830 may include a main memory 835, a static memory 840, and a storage unit 845 accessible to the processors 810 via the bus 805. The storage unit 845 may include a machine-readable medium 847 on which are stored the instructions 825 embodying any one or more of the methodologies or functions described herein. The instructions 825 may also reside, completely or at least partially, within the main memory 835, within the static memory 840, within at least one of the processors 810 (e.g., within the processor's cache memory), or any suitable combination thereof, during execution thereof by the machine 800. Accordingly, the main memory 835, static memory 840, and the processors 810 may be considered as machine-readable media 847.

As used herein, the term “memory” refers to a machine-readable medium 847 able to store data temporarily or permanently and may be taken to include, but not be limited to, random-access memory (RAM), read-only memory (ROM), buffer memory, flash memory, and cache memory. While the machine-readable medium 847 is shown in an example embodiment to be a single medium, the term “machine-readable medium” should be taken to include a single medium or multiple media (e.g., a centralized or distributed database, or associated caches and servers) able to store instructions 825. The term “machine-readable medium” shall also be taken to include any medium, or combination of multiple media, that is capable of storing instructions (e.g., instructions 825) for execution by a machine (e.g., machine 800), such that the instructions, when executed by one or more processors of the machine 800 (e.g., processors 810), cause the machine 800 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory (e.g., flash memory), an optical medium, a magnetic medium, other non-volatile memory (e.g., Erasable Programmable Read-Only Memory (EPROM)), or any suitable combination thereof. The term “machine-readable medium” specifically excludes non-statutory signals per sc.

The I/O components 850 may include a wide variety of components to receive input, provide and/or produce output, transmit information, exchange information, capture measurements, and so on. It will be appreciated that the I/O components 850 may include many other components that are not shown in FIG. 8. In various example embodiments, the I/O components 850 may include output components 852 and/or input components 854. The output components 852 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor), other signal generators, and so forth. The input components 854 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, and/or other pointing instrument), tactile input components (e.g., a physical button, a touch screen that provide location and force of touches or touch gestures, and/or other tactile input components), audio input components (e.g., a microphone), and the like.

In further example embodiments, the I/O components 850 may include biometric components 856, motion components 858, environmental components 860, and/or position components 862 among a wide array of other components. For example, the biometric components 856 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, finger print identification, or electroencephalogram based identification), and the like. The motion components 858 may include acceleration sensor components (e.g., accelerometer), gravitation sensor components, rotation sensor components (e.g., gyroscope), and so forth. The environmental components 860 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), and/or other components that may provide indications, measurements, and/or signals corresponding to a surrounding physical environment. The position components 862 may include location sensor components (e.g., a GPS receiver component), altitude sensor components (e.g., altimeters and/or barometers that detect air pressure from which altitude may be derived), orientation sensor components (e.g., magnetometers), and the like.

Communication may be implemented using a wide variety of technologies. The I/O components 850 may include communication components 864 operable to couple the machine 800 to a network 880 and/or devices 870 via coupling 882 and coupling 872 respectively. For example, the communication components 864 may include a network interface component or other suitable device to interface with the network 880. In further examples, communication components 864 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 870 may be another machine and/or any of a wide variety of peripheral devices (e.g., a peripheral device coupled via a USB).

Moreover, the communication components 864 may detect identifiers and/or include components operable to detect identifiers. For example, the communication components 864 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF48, Ultra Code, UCC RSS-2D bar code, and other optical codes), acoustic detection components (e.g., microphones to identify tagged audio signals), and so on. In additional, a variety of information may be derived via the communication components 864 such as location via Internet Protocol (IP) geo-location, location via Wi-Fi® signal triangulation, location via detecting a NFC beacon signal that may indicate a particular location, and so forth.

### Transmission Medium

In various example embodiments, one or more portions of the network 880 may be an ad hoc network, an intranet, an extranet, a virtual private network (VPN), a LAN, a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 880 or a portion of the network 880 may include a wireless or cellular network and the coupling 882 may be a Code Division Multiple Access (CDMA) connection, a Global System for Mobile communications (GSM) connection, or other type of cellular or wireless coupling. In this example, the coupling 882 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 825 may be transmitted and/or received over the network 880 using a transmission medium via a network interface device (e.g., a network interface component included in the communication components 864) and utilizing any one of a number of well-known transfer protocols (e.g., hypertext transfer protocol (HTTP)). Similarly, the instructions 825 may be transmitted and/or received using a transmission medium via the coupling 872 (e.g., a peer-to-peer coupling) to devices 870. The term “transmission medium” shall be taken to include any intangible medium that is capable of storing, encoding, or carrying instructions 825 for execution by the machine 800, and includes digital or analog communications signals or other intangible medium to facilitate communication of such software.

Furthermore, the machine-readable medium 847 is non-transitory (in other words, not having any transitory signals) in that it does not embody a propagating signal. However, labeling the machine-readable medium 847 as “non-transitory” should not be construed to mean that the medium is incapable of movement; the medium 847 should be considered as being transportable from one physical location to another. Additionally, since the machine-readable medium 847 is tangible, the medium 847 may be considered to be a machine-readable device.

### Term Usage

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
receiving a request from a client system to place a particular item in a shopping cart associated with a user of the client system;
detecting an abandonment action for the particular item;
in response to detecting the abandonment action for the particular item, incrementing a user-specific abandonment counter associated with the particular item;
determining whether the abandonment counter associated with the particular item is within a predefined range;
in accordance with a determination that the abandonment counter for the first item is within the predefined range, generating an offer for the particular item; and
transmitting the generated offer to the user associated with the client system.

2. The method of claim 1, wherein determining whether the abandonment counter associated with the particular item is within the predefined range comprises determining whether the abandonment counter is above a lower limit.

3. The method of claim 1, wherein detecting the abandonment action for the particular item comprises detecting that the user has closed a web page associated with an e-commerce system without purchasing the particular item.

4. The method of claim 1, wherein detecting the abandonment action for the particular item comprises detecting that at least a predetermined amount of time has elapsed since the request was received from the client system.

5. The method of claim 1, wherein detecting the abandonment action for the particular item comprises receiving a request to remove the particular item from the shopping cart.

6. The method of claim 1, wherein, after detecting the abandonment action for the particular item, incrementing a global abandonment counter for the particular item.

7. The method of claim 1, further comprising: in accordance with the determination that the abandonment counter for the particular item is within the predefined range, determining increased user purchasing intent for the particular item.

8. The method of claim 1, wherein generating the offer for the particular item further comprises: determining a list of one or more potential offers based on business rules associated with the particular item.

9. The method of claim 8, wherein the business rules associated with the particular item are received from a seller associated with the particular item.

10. The method of claim 9, wherein the seller is an individual or an organization.

11. The method of claim 8, wherein generating the offer for the particular item further comprises:
analyzing a user profile of the user, to determine one or more user preferences; and
based on the determined one or more user preferences, selecting at least one offer from a list of one or more potential offers.

12. The method of claim 11, wherein selecting at least one offer from the list of one or more potential offers further comprises:
ranking the one or more potential offers based on the one or more user preferences; and
choosing the potential offer that is ranked the highest.

13. The method of claim 1, further comprising, after transmitting the generated offer for the particular item to the client system: receiving a purchase request from the client system for the particular item.

14. The method of claim 13, further comprising storing purchasing information for the particular item based on the purchase request.

15. The method of claim 1, further comprising: storing, for each item, an abandonment rate, wherein abandonment rate is a ratio of a number of times a respective item is a placed in a shopping cart to a number of times the respective item is abandoned.

16. The method of claim 1, wherein generating the offer for the particular item further comprises:
transmitting abandonment data for the particular item to a seller associated with the particular item; and
receiving offer instructions from the seller associated with the particular item, wherein the offer instructions include an offer to be sent to the client system.

17. A server system comprising:
one or more processors configured to include:
a reception module to receive a request from a client system to place a particular item in a shopping cart associated with a user of the client system;
a detection module to detect an abandonment action for the particular item;
an increment module to, in response to detecting the abandonment action for the particular item, increment a user-specific abandonment counter associated with the particular item;
a determination module to determine whether the abandonment counter associated with the particular item is within a predefined range;
a generation module to, in accordance with a determination that the abandonment counter for the first item is within the predefined range, generate an offer for the particular item; and
a transmission module to transmit the generated offer to the user associated with the client system.

18. The server system of claim 17, further comprising:
an intent determination module to, in accordance with the determination that the abandonment counter for the particular item is within the predefined range, determine increased user purchasing intent for the particular item.

19. A non-transitory computer-readable storage medium storing instructions that, when executed by the one or more processors of a machine, cause the machine to perform operations comprising:
receiving a request from a client system to place a particular item in a shopping cart associated with a user of the client system;
detecting an abandonment action for the particular item;
in response to detecting the abandonment action for the particular item, incrementing a user-specific abandonment counter associated with the particular item;
determining whether the abandonment counter associated with the particular item is within a predefined range;
in accordance with a determination that the abandonment counter for the first item is within the predefined range, generating an offer for the particular item; and
transmitting the generated offer to the user associated with the client system.

20. The non-transitory computer-readable storage medium of claim 19, further comprising:
in accordance with the determination that the abandonment counter for the particular item is within the predefined range, determining increased user purchasing intent for the particular item.
